(19) United States
(12) Patent Application Publication
(10) Pub. No.: US 2003/0128989 A1
(43) Pub. Date: Jul. 10, 2003

(54) Laser transmitter and process for transmitting controlled light signals

(75) Inventors: Edith Beatrice Louise Gilon, Brussels (BE); Paul Gilbert Regina De Meulenaere, Edegem (BE); Peter Johannes Vetter, Antwerp (BE); Xing Zhi Qiu, Gent (BE); Jan Alfons Ida Maria Vandewege, Gent (BE)

Correspondence Address: SUGHRUE MION, PLLC, 2100 Pennsylvania Avenue, NW, Washington, DC, 20037-3213, US

(73) Assignee: ALCATEL

(21) Appl. No.: 10/317,075

(22) Filed: Dec. 12, 2002

(30) Foreign Application Priority Data
Dec. 13, 2001 (EP) 01403263.5

(51) Int. Cl. H04B 10/04

(52) U.S. Cl. 398/195; 398/197

(57) ABSTRACT

A laser transmitter comprising a laser diode (1) and a monitoring photodiode (2) adapted to receive a small part (LS1) of a light signal (LS) of the laser diode and to derive therefrom an output current (SC). The transmitter further comprises regulation means (4) adapted for receiving the output current and for sending a signal (CS) to a current driver (5) in order to regulate the input current (IC) of the laser diode (1) as a function of this output current (SC). The transmitter also comprises a register (6) adapted to store data to be used by the regulation means (4) or to be read by a serial interface, and pattern detection means (7) adapted to scan all the traffic and thus all the packets of the upstream flow to the laser diode (1) to check whether pre-determined bit-patterns are present.

This invention relates to a laser transmitter comprising a laser diode adapted to convert an input current into a light signal containing data information to be sent on an optical fiber, a monitoring photodiode adapted to receive a small part of said light signal and to derive therefrom an output current and regulation means adapted for receiving said output current and for sending a signal to a current driver for regulating said input current as a function of said output current.

The ratio between output light of the laser diode and the current of the photodiode is roughly linear. The monitoring of the current from the photodiode permits to adapt the current fed in the laser diode to obtain the expected light in the fiber. The laser driver comprises the regulation means receiving the output current from the monitoring diode and the current driver sending the input current to the laser diode.

The regulation time of the laser diode, i.e. the delay to obtain the expected light in the fiber, depends on the initial currents given to the laser diode and on the regulation speed.

Regulation time is a major problem for laser transmitters, especially in burst-mode transmission. Indeed, in burst-mode transmission, the power regulation is more complicated than in conventional continuous mode, as the regulation can not be done on the average power and needs to take place in a short timeslot.

A known burst-mode laser driver with regulation means uses a binary tree search between zero and the maximum current allowed in the diode, for controlling the power regulation. Another laser driver on the market uses an incremental regulation.

With these known laser drivers, the regulation time for the laser diode is too long, whereby the output light does fit the expected light in the fibers too slowly.

The present invention has for object a laser transmitter enabling a shorter regulation time, i.e. whereby the output light fits quicker the expected light.

This object is reached according to the invention by the fact that the laser transmitter comprises at least one register adapted to store data to be used by the regulation means for performing the regulation of said input current.

The regulation time is shorter because the values of the initial current given to the laser diode are better estimated, this is closer to the final value, and the regulation process is more efficient and faster.

The register is adapted to be written as well as to be read by external means, for instance a serial interface.

In this case, the register is preferably adapted to permit data to be read by the regulation means, and that the regulation means are adapted to permit data, for instance results of the regulation, to be written and stored in the register.

The data stored in the register may thus be information written by a suitable serial interface or “results” from the regulation itself.

The data stored in the register may comprise different parameters, such as current presets for different temperatures, monitoring current references, coupling factor between laser diode and monitoring photo diode, monitoring capacitance, value of temperature, or current settings or other parameters.

Preferably, the data stored in the register result from prior analysis or tests, for example from one or more of the following data: data sheets, statistics, statistical studies of the optical modules, optical calibration, extrapolations.

The register may be a memory or a system for reading a memory support, for example an external memory.

The invention also relates to a laser transmitter according to the first paragraph, which further comprises pattern detection means connected to the regulation means.

During the power set-up of Burst mode laser drivers, the laser diode transmit control cells (for example PLOAM or Physical Layer Operation Administration and Maintenance) prior to the data cells in order to adjust the transmission power of the Optical Network Termination. Each cell comprises in its payload a Laser Control Field (LCF) that has a particular pattern allowing the power regulation of the laser driver.

Laser transmitters are thus known with means detecting this particular pattern.

However a long series of ten or more PLOAM cells have to be transmitted to adjust the transmission power. The power set-up phase is therefore relatively long and a long waiting time is required before the data cells can be transmitted.

An object of the invention is also to decrease the regulation time.

According to the invention, this object is met by the fact that the pattern detection means are adapted to scan all the traffic and thus all the packets of the upstream flow to the laser diode to check whether pre-determined bit-patterns are present.

As not only the LCF of control cells (PLOAM) is used for adjusting the power settings, but other patterns in these control cells or even in other packets such as a in data cells or programmable cells, less control cells are required for ensuring a good initial regulation within a short lapse of time. The regulation time is shortened.

In still another embodiment, both above mentioned embodiments are combined. The laser transmitter may then comprise at least one register as well as pattern detection means.

In this case the time reductions for regulation obtained by the above mentioned embodiments are added up.

The invention also relates to a process for transmitting controlled light signals from a laser diode on an optical fiber, according to which a small part of the light signal of the laser diode is sent to a monitoring photo diode which converts it to an output current and this output current is monitored and used in regulation means which send a control signal to a current driver for adapting the input current to the laser diode.

According to the invention, this process is characterized in that, at least for a first initialization step, data are sent to the regulation means from at least one register wherein these data are stored, and the input current to the laser diode is adapted taking into account these data.

Instead of, or together with sending certain data to the regulation means, another characteristic embodiment of the present process is that at least one predetermined bit-pattern is detected in the upstream flow of packets to the laser diode and this information is also used for regulating the input current to the laser diode.

Also detecting whether a predetermined bit-pattern is present in any type of packets permit to decrease the regulation time.

Other details and characteristics of laser transmitters of the invention will appear from the following description in which reference is made to the attached drawings, wherein:

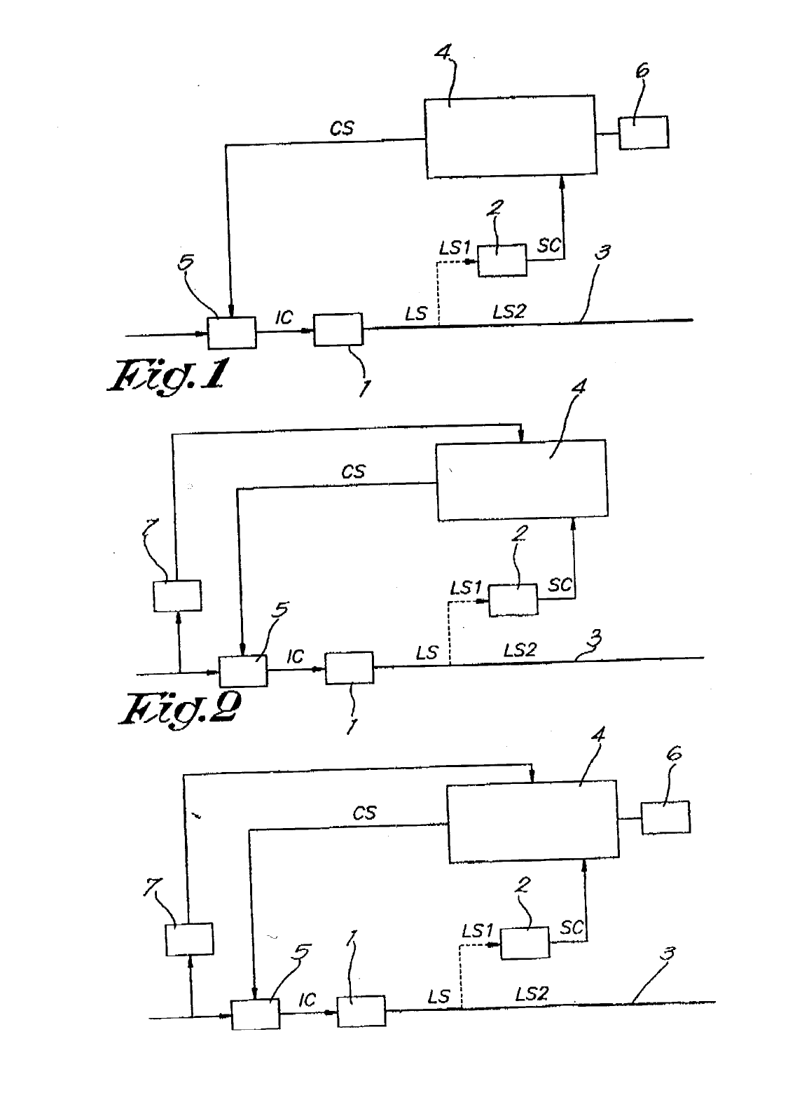

FIG. 1 is a block diagram of a laser transmitter according to the invention;

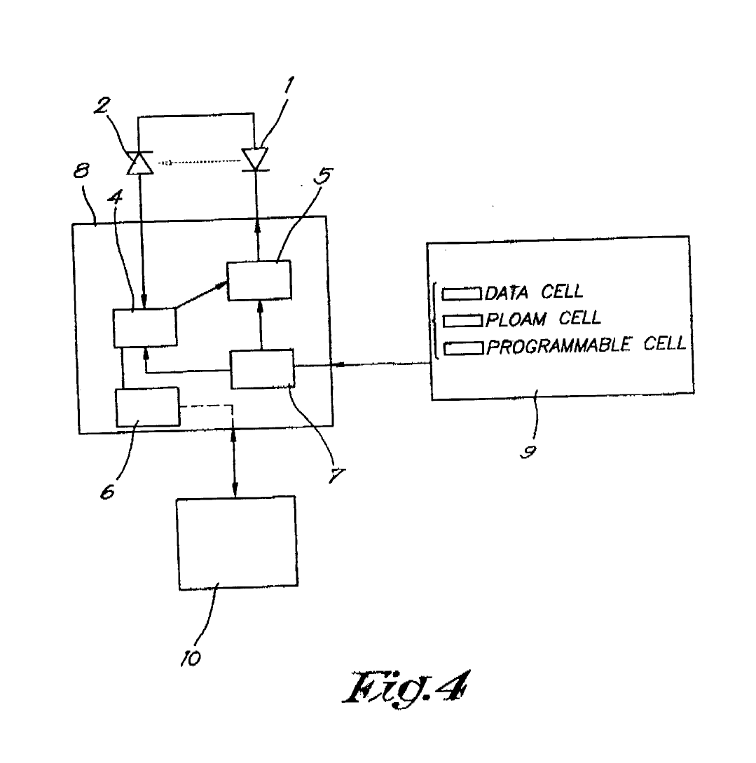

FIGS. 2 and 3 are block diagrams similar to the one of FIG. 1, but pertaining to other embodiments;

FIG. 4 is a further block diagram of a practical application of a laser transmitter of the invention.

The laser transmitter shown in FIG. 1 comprises:

a laser diode 1 receiving an input current IC and emitting a light signal LS;

a photo diode 2 receiving a small part LS1 of the light signal LS and converting said part in a small outlet current SC;

an optical fiber 3 receiving the main light LS2;

regulation means 4 receiving the small outlet current SC and emitting a regulating or control signal CS to a control system or current driver 5 controlling the value of the input current IC.

The regulation means 4 are connected to at least one register 6. This register 6 may be a memory or a system for reading a memory support, for instance an external memory. The register 6 contains various information or data with high speed access, such as current presets for different temperatures, monitoring current references, coupling factor between laser diode 1 and monitoring photo diode 2, monitoring capacitance, a measured value of temperature, current settings etc.

This information results from prior analysis or tests, for example from data sheets, statistics, statistical studies of the optical modules, optical calibration, extrapolations, etc.

The data are written in the register 6, either, by a suitable serial interface, or by the regulation means 4. In the first case the data are read by the regulation means 4 and in the second case the data, for instance results of the regulation, are read by a suitable serial interface.

The data stored in the register may be modified during operation. At the beginning they receive for instance a value (for example chosen or determined by calibration and/or extrapolation), but during operation, the value may possibly be modified.

After receiving an initial input current IC, the laser diode 1 emits a light signal LS, whereby the photodiode 2 emits a small current SC to the regulation means 4. In these regulation means 4, the control signal CS is determined in function of one or more data from the register 6 corresponding to the small output current SC.

The determination can be a direct determination, i.e. the control signal CS is directly furnished from the register 6 for the small output current SC, or an indirect determination (computing step). The control signal CS is then used for controlling the initial input current IC provided to the laser diode 1.

Some data stored in the register 6 may be read by external means, for example a suitable serial interface.

As due to the information of the register 6 the input current IC will have a better value and a better choice of the speed regulation is possible, the laser diode 1 produces faster an optimal light. An optimal light is a light the characteristics of which correspond to the characteristics of the expected light to be sent into the fiber 3.

The regulation time is very short. The register 6 will be as accurate as possible in order to produce the best possible immediate control signal CS.

FIG. 2 is a block diagram of another embodiment of a laser transmitter according to the invention.

This embodiment comprises also

a laser diode 1 receiving an input current IC and emitting a light signal LS;

a monitoring photo diode 2 receiving a part LS1 of the light signal LS and converting said part in a small current SC;

an optical fiber 3 receiving the remaining light LS2;

regulation means 4 receiving the small output current SC and emitting a control signal CS to a control system or current driver 5 controlling the value of the input current IC;

but instead of one or more registers 6, it contains a pattern detection means 7 adapted for detecting predetermined patterns in all packets of the upstream flow to the laser diode 1 and for furnishing a signal to the regulation means 4.

The detection means 7 are scanning means enabling to extract the maximum possible set-up information from monitoring the upstream traffic.

Such detection means 7 scan all packets and are adapted for detecting one or more bit-patterns which are substantially identical to the predetermined bit-pattern.

All packet types may be scanned, partially or completely. Preferably complete packets are scanned. The scanned packets may be as well control cells (PLOAM) as data cells or programmable cells or a combination thereof.

Indeed, the determined bit-pattern detectable by the pattern detection means 7 must not necessarily be comprised in control cells. It may also be contained in a data cell or a programmable cell.

Each PLOAM or control cell comprises a laser control field (LCF), as well as other fields in which the presence of bit-patterns (typically long series of zeroes or ones).

As more than the LCF pattern of the control or PLOAM cells is used for adjusting the power settings, less control cells are required for ensuring a good initial regulation within a short lapse of time. The regulation time is shortened.

It has been observed that with the scanning detection means 7, less than five, for example two to four, control cells are sufficient for ensuring an accurate and adequate regulation via the regulation means 5.

The detection means 7 can possibly be integrated in the regulation means 4.

If the packets are programmable cells, these cells enable to define specific field to be analyzed. The programmable cells are for example adapted for receiving one or more specific patterns, which are thereafter detected or compared in the detection means 7.

The embodiment of FIG. 3 is similar to the one of FIG. 1, except that the regulation means 4 are not only connected to a register 6 but also connected to a pattern detection means 7 as in the embodiment of FIG. 2.

As soon as the regulation means 4 receive a signal from the pattern detection means 7 that a predetermined bit-pattern has been detected in the packets, the control signal CS is determined by the regulation means 4 taking into account the data from the register 6, at least for the initialization step.

FIG. 4 is a schematic view of practical embodiment of a laser transmitter comprising a burst driver 8 connected to a laser diode 1 and a photodiode 2, as well as to an APON network termination 9 able to send data cells, PLOAM cells and programmable cells.

The burst driver 8 comprises regulation means 4 receiving the output signal SC of the photo diode 2 and sending a control signal CS to the control system or current driver 5 controlling the input current of the laser diode 1 at least during the initialization step.

The burst driver 8 also comprises a pattern detection means 7 and the cells of the network termination 9 are sent over the current driver 5 to the laser diode 1 and to the pattern detection means 7. These detection means 7 give indications about the presence of a pattern in the cells to the regulation means 4.

The burst driver also comprises a register 6 in connection with the regulation means 4 and a serial interface 10 connected to the register 6 and adapted to read and write in the register 6. Data are written in the register 6 by the serial interface 10 and read by the regulation means 4. Data could also be written in the register 6 by the regulation means 4 and read by the serial interface 10.

1. Laser transmitter comprising a laser diode (1) adapted to convert an input current (IC) into a light signal (LS) containing data information to be sent on an optical fiber (3), a monitoring photodiode (2) adapted to receive a small part (LS1) of said light signal and to derive therefrom an output current (SC) and regulation means (4) adapted for receiving said output current and for sending a signal (CS) to a current driver (5) for regulating said input current (IC) as a function of said output current (SC), characterized in that the laser transmitter comprises at least one register (6) adapted to store data to be used by the regulation means (4) for performing the regulation of said input current (IC).

2. Laser transmitter according to claim 1, characterized in that the register (6) is adapted to be written as well as to be read by external means, for instance a serial interface (10).

3. Laser transmitter according to claim 1, characterized in that the register (6) is preferably adapted to permit data to be read by the regulation means (4), and in that the regulation means are adapted to permit data, for instance results of the regulation, to be written and stored in the register (6).

4. Laser transmitter according to claim 1, characterized in that the data stored in the register (6) comprise different parameters, such as current presets for different temperatures, monitoring current references, coupling factor between laser diode and monitoring photo diode, monitoring capacitance, value of temperature, current settings or a combination thereof.

5. Laser transmitter according to claim 1, characterized in that the data stored in the register (6) result from prior analysis or tests, such as data sheets, statistics, statistical studies of the optical modules, optical calibration, extrapolations.

6. Laser transmitter according to claim 1, characterized in that the register (6) comprises at least one memory or a system for reading a memory support, such as an external memory.

7. Laser transmitter comprising a laser diode (1) adapted to convert an input current (IC) into a light signal (LS) containing data information to be sent on an optical fiber (3), a monitoring photodiode (2) adapted to receive a small part (LS1) of said light signal and to derive therefrom an output current (SC) and regulation means (4) adapted for receiving said output current and for sending a signal (CS) to a current driver (5) for regulating said input current (IC) as a function of said output current (SC), which further comprises pattern detection means (7) connected to the regulation means, characterized in that the pattern detection means (7) are adapted to scan all the traffic and thus all the packets of the upstream flow to the laser diode (1) to check whether pre-determined bit-patterns are present.

8. Laser transmitter according to claim 7, characterized in that the pattern detection means (7) are adapted to scan partially or completely incoming cells, such as data cells, control cells (PLOAM) and programmable cells.

9. Laser transmitter according to claim 1, characterized in that the laser transmitter further comprises pattern detection means (7) connected to said regulation means (4) and adapted to scan all the traffic and thus all the packets of the upstream flow to the laser diode (1) to check whether pre-determined bit-patterns are present.

10. Process for transmitting controlled light signals from a laser diode (1) on an optical fiber (3), according to which a small part (LS1) of the light signal (LS) of the laser diode (1) is sent to a monitoring photo diode (2) which converts it to an output current (SC) and this output current is monitored and used in regulation means (4) which send a control signal (CS) to a current driver (5) for adapting the input current (IC) to the laser diode (1), characterized in that, at least for a first initialization step, data are sent to the regulation means (4) from at least one register (6) wherein these data are stored, and the input current (IC) to the laser diode (1) is adapted taking into account said data.

11. Process according to claim 10, characterized in that data stored in the register (6) are read by external means, for instance a serial interface (10).

12. Process for transmitting controlled light signals from a laser diode (1) on an optical fiber (3), according to which a small part (LS1) of the light signal (LS) of the laser diode (1) is sent to a monitoring photo diode (2) which converts it to an output current (SC) and this output current is monitored and used in regulation means (4) which send a control signal (CS) to a current driver (5) for adapting the input current (IC) to the laser diode (1), characterized in that at least one predetermined bit-pattern is detected in the upstream flow of packets to the laser diode (1) and this information is also used for regulating the input current (IC) to the laser diode (1).

13. Process according to claim 10, characterized in that at least one predetermined bit-pattern is detected in the upstream flow of packets to the laser diode (1) and this information is used, together with said data, for regulating the input current (IC) to the laser diode (1).
